(19) United States
(12) Patent Application Publication
(10) Pub. No.: US 2009/0144662 A1
(43) Pub. Date: Jun. 4, 2009

(54) Method for Menu Navigation

(75) Inventors: Phillip H. Salvatori, Salem, OR (US); Randolph W. Nash, McMinnville, OR (US); Thomas A. Andersen, Krakeroy (NO)

Correspondence Address: ALLEMAN HALL MCCOY RUSSELL & TUTTLE LLP, 806 SW BROADWAY, SUITE 600, PORTLAND, OR, 97205-3335, US

(73) Assignee: InFocus Corporation, Wilsonville, OR (US)

(21) Appl. No.: 12/370,911

(22) Filed: Feb. 13, 2009

Related U.S. Application Data
(63) Continuation of application No. 10/439,008, filed on May 14, 2003.

(51) Int. Cl. G06F 3/048

(52) U.S. Cl. 715/841

(57) ABSTRACT

According to a first embodiment, the present invention provides a menu navigation system associated with an electronic device. The menu system may include a menu cascade and a user-interface. The user-interface may display a level indicator, which indicates the level of one of the linked menus in the menu cascade.

### CROSS REFERENCE TO PARENT APPLICATION

This present application is a continuation of U.S. application Ser. No. 10/439,008, filed May 14, 2003, entitled “Method for Menu Navigation,” naming Phillip H. Salvatori, Randolph W. Nash, and Thomas A. Andersen as inventors, the entire contents of which are incorporated herein by reference.

### TECHNICAL FIELD

The present invention relates generally to electronic devices, and more particularly, to the navigation of menus in technological systems on electronic devices.

### BACKGROUND

Menus are commonly used for navigation of technological systems on electronic devices. For example, users often encounter menus on a user display when setting up and using electronic devices, such as televisions (TVs), computers, videocassette recorders (VCRs), projectors, etc. Typically, the user is first presented with an introductory user-interface, often called a “main menu” that provides the user with a set of selectable options. Selecting an option may take the user to another user-interface, or submenu, with a second set of selectable options, including alterable settings, informational content, etc. Often menus are cascaded, whereby it is meant that a first-level menu, including a set of selectable options, may be linked to a plurality of second-level menus, some, or all of which, include a set of selectable options. The selectable options on the second-level menus may be, in turn, linked to a plurality of third-level menus, some, or all of which, include a set of selectable options, which may be linked to a set of fourth-level menus, and so on.

Users of these cascading menu systems can quickly become lost, having lost track of how many menus deep they are in the cascade. It also may be frustrating to figure out how to get to a desired menu, which may be in a different cascade pathway. This may lead to frustration and general dissatisfaction with the device.

Moreover, many menu navigation systems require the device to include, and the user to operate, complicated controller mechanisms. These controller mechanisms often include buttons, trackballs, or other input devices, which are primarily intended for purposes other than menu navigation. For example, many television remote controls use the channel/volume control buttons for menu navigation. Because the buttons are primarily intended for other purposes, the manner in which these buttons control menu navigation may be counter-intuitive and frustrating for some users.

### SUMMARY

According to a first embodiment, the present invention provides a menu navigation system associated with an electronic device. The menu system may include a menu cascade and a user-interface. The user-interface may display a level indicator, which indicates the level of one of the linked menus in the menu cascade.

### BRIEF DESCRIPTION OF THE DRAWINGS

FIG. 1 provides a schematic layout of a menu cascade.

FIG. 2 provides a schematic layout of a menu cascade incorporating a menu navigation system of the present invention.

FIG. 3 provides a schematic layout of another menu cascade incorporating a menu navigation system of the present invention.

FIG. 4 provides a schematic layout of a menu cascade suitable for use with a projector according to an embodiment of the present invention.

FIG. 5 is a schematic depiction of the layout of exemplary user-operated controls suitable for use with the menu navigation systems shown in FIGS. 2-4.

FIG. 6 is a schematic illustration of a device that may operate the menu navigation system shown in FIGS. 1-4.

### DETAILED DESCRIPTION

The present invention provides a method for navigating a menu system for an electronic device. Typically, the menu system includes a plurality of linked menus. For the purposes of the present invention, and unless otherwise specified, the terms “linked” when used in reference to “linked menus” should be interpreted to mean that at least one menu can be accessed from another menu. Moreover, a “parent menu” is defined as a menu from which one or more “child menus” can be accessed. Consequently, a “child menu” is a menu that can be accessed via a “parent menu.”

The menus in the menu system may be presented to the user in the form of a user-interface. The user-interface may be presented on a display. For example, the image may be presented on a digitized image projected on a screen or on an electronic display. The user-interface may take the form of a window or screen image viewable by the user on the display. The user-interface may depict words, letters, numbers, icons or any other suitable graphic representation.

Moreover, each menu in the cascade may include displayable information. The displayable information may include, without limitation, level indicators, headers, user-selectable options, settings and/or other information, as described in more detail below. It will be appreciated that some or all of the displayable information for a particular menu may be incorporated into, and thus, displayed to the user by, the user-interface for that menu.

Typically, the user is able to view the user-interface via a display associated with an electronic device. As a non-limiting example, the device may be a projection device (shown at 9 in FIG. 6), a projector or image-generating device, such a projection device may be adapted to project the menu system onto a wall, screen or other viewing area. As used herein, a projection device or image-generating device may include any suitable display device or image projector, including, but not limited to, a digital projector, a liquid crystal display (LCD) projector, a digital light processing projector, etc.

Alternatively, the device may be a device having a built-in display unit, such as a television or computer, and the user-interface may be viewed on the built-in display unit, i.e., the television screen or computer screen. As a further alternative, the device may be linked to a separate, or external, display unit, such as a VCR linked to a television. In this case, the user-interface for the menu system may be transmitted to, and then viewed on, the external display unit. As other non-limiting examples, the device may include telephones, personal portable computers, personal data assistants (PDAs), DVD players, etc.

Typically, the device, such as projection device 9, in its most basic form, includes both a processor 11 and memory 13. Although shown in FIG. 6 as resident on the projection device, it should be appreciated that the processor and memory described above may be resident on a linked computing device, such as a computer, portable computer, portable data assistant, server, camera, control unit, telephone, etc.

Processor 11 may take the form of a central processing unit (CPU), or other suitable controller for controlling operation of the device. Processor 11 thus may be configured to manage operation and function of the device. For example, processor 11 may manage operational programs, user-interface programs and menu programs, such as the menu navigation system, described herein, etc.

Memory 13 may include both volatile memory and non-volatile memory. Non-volatile memory may be utilized to store permanent or semi-permanent data, such as the menu cascade and other information, described herein. Such non-volatile memory may be any suitable type of non-volatile memory, including, but not limited to, ROM, PROM, EPROM, EEPROM and Flash memory, and combinations thereof. Volatile memory may be utilized to store temporary data, including images and instructions. Volatile memory may include one or more suitable types of volatile memory, such as SRAM or DRAM.

It should be appreciated that for the purposes of the present invention, the “user” is not limited to the ultimate consumer of the device, but may also include a technician, manufacturer, or any other person who may operate or access the menu system.

According to one embodiment of the present invention, a plurality of linked menus may be arranged in a cascading fashion. For the purposes of the present invention, the terms “cascade” or “menu cascade” should be interpreted to refer to a menu layout where linked menus are arranged in a series of tiered levels. In this arrangement, a parent menu on a higher level may provide access to one or more child menus on a lower level. It should be understood that a child menu may also be a parent menu (and vice versa).

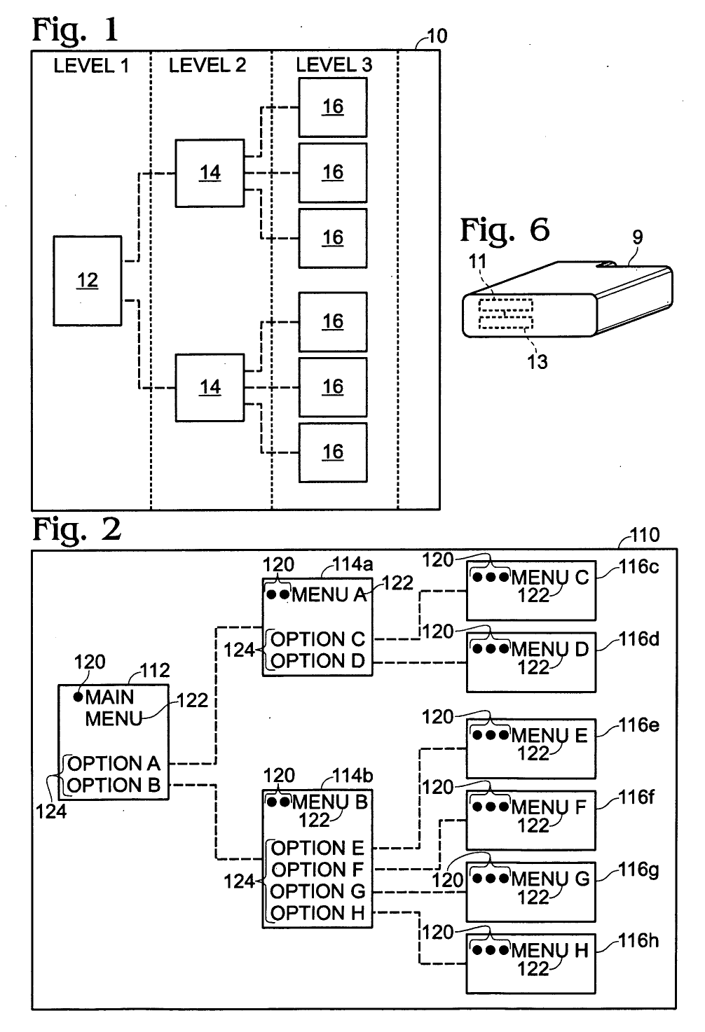

For example, the menu cascade 10 shown in FIG. 1 includes three levels. The first level includes a single parent menu 12 from which two child menus 14 can be accessed. These child menus reside on the second level of the cascade. However, each child menu is itself a parent menu providing access to three additional child menus 16 residing on the third level of the cascade. Thus, the status of each menu as a parent or child is contextual. In contrast, the level of each menu in a particular cascade is static, determined solely by the number of menus that precede the menu in that cascade.

FIG. 2 provides a schematic illustration of an exemplary menu cascade 110 according to the present invention. Menu cascade 110 includes a first-level menu 112, which may also be referred to as the initial or main menu, two second-level menus 114a and 114b and six second-level menus 116c-116h. Of course, it will be appreciated that any number of second and third-level menus may be incorporated into the cascade. Furthermore, while only three levels of menus have been shown for simplicity, the cascade may include any number of fourth, fifth, sixth or higher-numbered levels. Likewise, it should be appreciated that while main menu 112 is typically the first menu presented when a user accesses the menu system, and thus, is typically the only first-level menu, in some contexts it may be appropriate to include more than one first-level menu, for example, if the system includes more than one menu cascade.

As shown in FIG. 2, each menu includes a level indicator 120. The level indicator or level identifier is a visual representation of the level on which the menu resides. The level indicator may be displayed on any suitable or desirable location on the user-interface.

In the embodiment shown, the level indicator is a set of dots. The number of dots in the set corresponds to the level of the menu. Thus, as a first-level menu, the level indicator on menu 112 includes one dot. As second-level menus, the level indicators on menus 114a and 114b include two dots. As third-level menus, the level indicators on menus 116c-116h include three dots. It will be appreciated that fourth-level menus would include four dots, fifth-level menus would include five dots, etc. Of course, it will also be appreciated that the level indicators need not take the form of dots. The level indicators may be presented as one or more numbers, letters, words, dashes, lines, icons or any other graphic representation.

As stated above, in some devices, it may be desirable to provide multiple menu cascades. Moreover, it may be desirable for a particular menu to be accessible via more than one cascade. In such a case, the particular menu may reside on different levels in the different cascades. In this case, the menu may be associated with one level indicator when accessed via the first cascade and with a different level indicator when accessed via the second cascade. Thus, the level indicator identifies the level of the menu within a particular cascade, and a menu that is accessible from multiple cascades may have a different level indicator in each cascade.

The menus may include a header 122. The header is typically a way of identifying the particular menu and may be descriptive of the content of the menu. The header may, but need not necessarily, be displayed near or adjacent the level indicator.

As shown in FIG. 2, the menus may include a set of user-selectable options 124. These user-selectable options may be presented as a linear list of options, as in the embodiment depicted, or may be presented in any other suitable fashion, as previously discussed. The names of the user-selectable options for the parent menu may be used as the headers for the child menus. Such user-selectable options may act as links from the parent menu to the corresponding child menu. Thus, a user who selects Option A on Main Menu 112 may be directed to Menu A 114a.

The menus in FIG. 2 include displayable information, such as level indicators 120, headers 122 and user-selectable options 124. It should be appreciated that any or all of the displayable information for a particular menu may be incorporated into the user-interface for that menu.

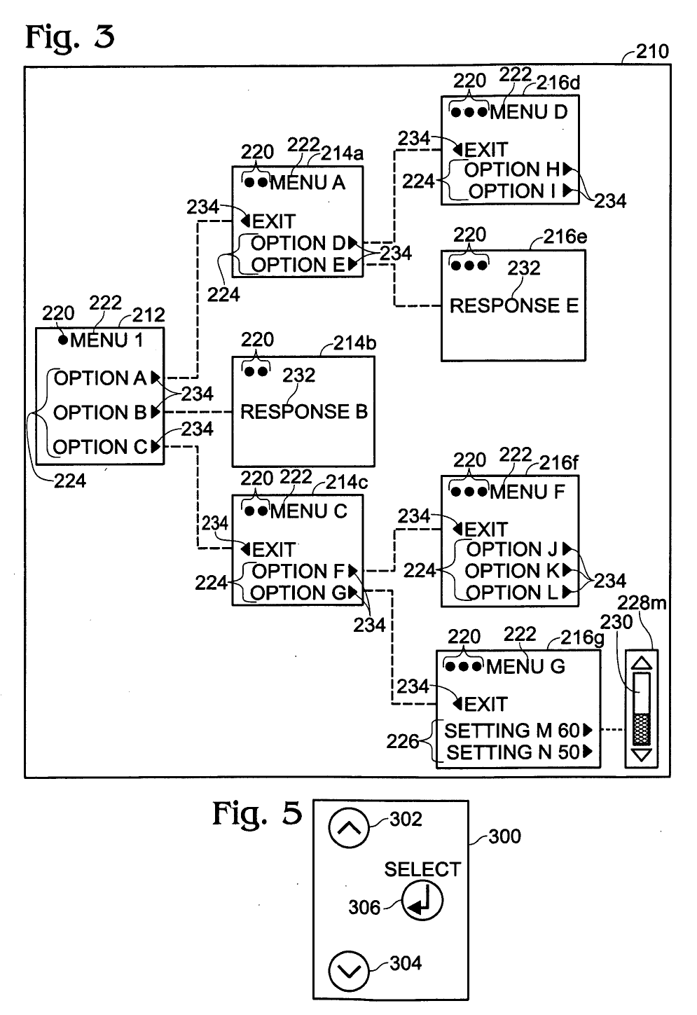

FIG. 3 provides a schematic illustration of another exemplary menu cascade 210 according to the present invention. Menu cascade 210 includes a first-level main menu 212, three second-level menus 214a-214c and four third-level menus 216d-216g. As before, it should be appreciated that any number of second, third, fourth, fifth, sixth or higher-numbered level menus may be incorporated into cascade 210. Likewise, it should be appreciated that while main menu 212 is typically the first menu presented when a user accesses the menu system, and thus, is typically the only first-level menu, in some contexts it may be appropriate to include more than one first-level menu.

As with the example depicted in FIG. 2, each of the menus in cascade 210 includes displayable information, including but not limited to, level indicator 220, header 222, user-selectable options 224, settings 226 and/or informational content 232. As previously stated, the user-selectable options 224 are typically items, which, when selected, direct the user to one or more additional menus in the menu cascade. The user may then be presented with the user-interface appropriate for the additional menu.

Settings 226 may alter various aspects of the device with which the menu system is associated. Menu 216g is an example of a menu providing access to two different settings, M and N. When a user selects one of the settings, a pop-up window may appear. This window may include a mechanism by which the user can alter the setting. For example, setting M may be a volume control. When the user selects setting M, pop-up window 228m appears. Pop-up window 228m includes a movable slider 230, which the user can raise or lower the slider in order to increase or decrease the volume.

As stated above, some of the user-interfaces may provide informational content 232, as with menus 214b and 216e. This informational content may include text, images or the like. Suitable informational content may be, for example, confirmation that a particular setting has been selected or altered, information about the device with which the menu system is associated, purchasing information, contact information, etc.

Some or all of the user-selectable options may be associated with directional indicators 234. Typically, the directional indicators indicate the direction of the menu accessed by activating a given user-selectable option. Thus, when a user-selectable option includes or is followed by a directional indicator that points to the right, the directional indicator may indicate that the menu for the user-selectable options lies to the right of the present menu, and therefore, is a child of the present menu. Correspondingly, when a user-selectable option includes or is followed by a directional indicator that points to the left, the directional indicator may indicate that the menu for the user-selectable option lies to the left of the present menu, and therefore, is a parent of the present menu.

For example, Option A on menu 212 includes a directional indicator that points to the right, indicating that Menu A is a child to menu 212. Similarly, the Exit option on menu 214a includes a directional indicator that points to the left, indicating that the corresponding menu that is accessed by selecting the Exit option is a parent to menu 214a.

In the example shown, the directional indicators take the form of left and right pointing arrowheads. However, it will be appreciated that the arrowheads could alternatively point up and down. Moreover, the directional indicators may take any suitable form including arrows, words, icons, characters, etc. Furthermore, if desired, the directional indicator could indicate the menu level of the menu that is accessed by selecting the associated user-selectable option.

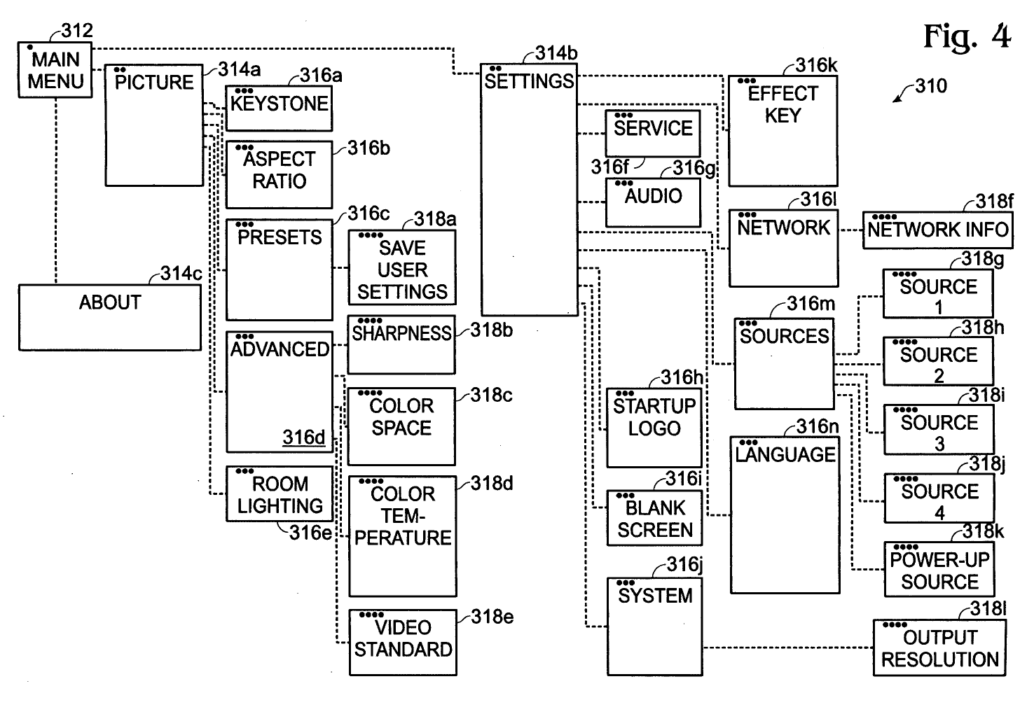

FIG. 4 is an exemplary menu cascade 310 for use with a projector or similar device. Those of skill in the art will be familiar with suitable projectors such as those commercially available from InFocus, Corp. (Wilsonville, Oreg.). It should be understood that the specific menu configurations, options and graphic representations described below are intended to be non-limiting examples, recited for the purpose of providing a better understanding of the invention, and that other configurations, options and graphic representations are contemplated by the present invention.

Typically, menu cascade 310 is accessed by a user during set-up and/or operation of a projector. For example, a user may access menu cascade 310 to alter or select settings, troubleshoot, etc.

Cascade 310 includes a single first-level menu 312. First-level menu 312 includes a level indicator showing a single dot. First level menu 312 may further include user-selectable options. Examples of such user-selectable options include Exit options, Picture options, Settings options, and About options. Selecting an Exit option may take the user out of the menu system while an About option may provide an Informational Menu (as indicated at 314c). The Informational menu may describe various characteristics of a particular projection device or projector system.

Some of the user-selectable options may link to second-level menus. For example, in some embodiments, selecting a Picture option from a first-level menu 312 may take the user to second-level Picture menu 314a. Similarly, selecting a Settings option from a first-level menu 312 may take the user to a second-level Settings menu 314b.

Some, none, or all of the user-selectable options may include directional indicators. The directional indicators may indicate, as described above, that child menus exist for these options and that selecting one of these options will take the user to the child menu for the selected option.

As described above, the second-level Picture menu 314a may include a level indicator showing two dots, indicating that it is a second-level menu. Picture menu 314a further may include any number of user-selectable options, including, but not limited to, Exit options, Keystone options, Contrast options, Brightness options, Color options, Tint options, Aspect Ratio options, Presets options, Advanced options, and Room Lighting options. Moreover, the options may include directional indicators, which indicate that selecting one of these options will take the user to the child menu for the selected option.

Instead of directional indicators, some user-selectable options on the menu (such as Contrast option, Brightness option, Color option and Tint option) may be associated with numerical values (not shown). These numerical values may represent an adjustable value at which the associated option is currently set. Selecting one of these options may result in the appearance of a pop-up window including an adjustable scale, such as that shown and described above with respect to FIG. 3.

The Exit option on the second-level Picture menu 314a may include a directional indicator indicating that selecting the Exit option will take the user to the parent menu for the Exit option, which in this case is first-level menu 312. Note that in this example, selecting the Exit option from the Picture menu does not take the user out of the menu system, but instead takes the user one level up in the menu cascade. Of course, it will be appreciated that this or any other Exit option could be set to take the user out of the menu system entirely.

It should be appreciated that not all options may be available at all times. For example, when no image is shown on the projector screen, the Contrast option, Brightness option, Color option and Tint option may be grayed out, indicating that such an option is unavailable to the user.

In the exemplary embodiment, multiple third-level menus may be accessible through the user-selectable options on second-level Picture menu 314a. For example, a user may access third-level menus, such as Keystone menu 316a, Aspect Ratio menu 316b, Presets menu 316c, Advanced menu 316d and Room Lighting menu 316e. Each of these menus includes level indicators (e.g., three dots) indicating that the menus are third-level menus. Moreover, each of these menus may include a user-selectable Exit option (not shown). The Exit option may include a directional indicator (not shown) indicating that selecting this option will take the user up one level in the present cascade, e.g., to the Picture menu.

As described in relation to the other menus, the third-level menus may include selectable options. For example, Keystone menu 316a may include selectable options such as Exit, Horizontal and Vertical (not shown). The Horizontal and Vertical options may include numerical values (not shown) indicating that selecting one of these options will allow a user to adjust the horizontal and vertical settings in any suitable manner, such as by using an adjustable slider as described above.

Similarly, Aspect Ratio menu 316b may include selectable options such as Exit, Native, 16:9, 4:3 and Non-Linear (not shown). In this menu, the Native, 16:9, 4:3 and Non-Linear selectable options may be followed by radio buttons (not shown), which indicate that the user can select an aspect ratio for the projection device's display screen from the presented options.

Presets menu 316c may include user-selectable options such as Exit, Home Theater, Presentation, Photography, User 1, User 2, User 3 and Save User Settings (not shown). The Home Theater, Presentation, Photography, User 1, User 2 and User 3 options may include radio buttons (not shown) indicating that the user may select from between them. In some embodiments, the Save User Settings option may include a directional indicator (not shown) indicating that selecting the Save User Settings option will take the user to an associated child menu.

Selection of the Save User Settings option, may link a user with a fourth-level menu, the Save User Settings menu 318a. The Save User Settings menu 318a may include a level indicator with four dots, indicating that the Save User Settings menu is a fourth-level menu. The Save User Settings menu also may include user-selectable options such as Exit, Save User 1, Save User 2 and Save User 3 (not shown). The Exit option may include a directional indicator (not shown) indicating that selecting this option will take the user back to a parent menu as such, the Presets menu or other menu in the cascade.

As described with the other menus, Advanced menu 316d may include selectable options such as Exit, Sharpness, Color Space, Color Temperature, Video Standard, Overscan, Phase, Tracking, H Position and V Position. Some of these options may link with a fourth-level child menu, such as Sharpness menu 318b, Color Space menu 318c, Color Temperature menu 318d and Video Standard menu 318e. Each of these child menus may include level indicators indicating that these are fourth-level menus.

Each child menu may include selectable options. For example, Sharpness menu 318b may include selectable options such as Exit, Sharpest, Sharper, Standard, Softer and Softest (not shown). Color Space menu 318c may include selectable options such as Exit, Auto, RGB, SMPTE240, REC709 and REC601 (not shown). In some embodiments, the Auto option may include a check box (not shown) that enables the user to turn this feature on and off. For example, in some embodiments, when Auto option is “checked,” the other selectable options (such as RGB, SMPTE240, REC709 and REC601) may be grayed out such that the user cannot individually select any one of the options. However, although such selectable options are grayed out, the user can still identify which item was selected by the Auto function. Moreover, the RGB, SMPTE240, REC709 and REC601 options may be linked to the Auto option such that when the Auto option is unchecked the RGB, SMPTE240, REC709 and REC601 options are available to the user.

Color Temperature menu 318d may include user-selectable options such as Exit, 5500K, 6500K, 7300K, 8200K, 9300K, User, Red, Green and Blue (not shown). The 5500K, 6500K, 7300K, 8200K, 9300K and User options may include radio buttons (not shown), indicating that a user may select from between these options. The Red, Green and Blue options may be linked to the User option such that when the User option is selected, the Red, Green and Blue options are enabled and the user can alter their settings using any suitable method including the pop-up window and movable slider described above.

Video Standard menu 318e may include user-selectable options such as Exit, Auto, NTSC, PAL and SECAM (not shown). The Auto option may be associated with a check box (not shown), by which the user can turn the Auto option on and off. As discussed above, when Auto option is “checked,” the other selectable options (such as NTSC, PAL and SECAM) may be grayed out such that the user cannot individually select one of the options. The grayed out options may still be viewable, such that a user can identify which item was selected by the Auto function. The NTSC, PAL and SECAM options may be linked to the Auto option, such that when the Auto option is unchecked the NTSC, PAL and SECAM options are available to the user.

Another exemplary menu linked to second-level Picture menu 314a is third-level menu Room Lighting menu 316e, which may include one or more selectable options such as Exit, ARLS, Dark and Light (not shown). The ARLS setting may be associated with a check box (not shown and described generally above), allowing the user to turn the ARLS option on and off. The Dark and Light options may be linked to the ARLS option such that when the ARLS option is unchecked, the Dark and Light options are available to the user.

Similar to second-level Picture menu 314a, second-level Settings menu 314b may provide access to a multiple child menus. Settings menu 314b may include a level indicator showing two dots and one or more user-selectable options such as Exit, Audio, Sources, System, Startup Logo, Blank Screen, Effect Key, Network, Language and Service (not shown). Some of these options link a user to a third-level menu, such as an Effect Key menu 316k, Network menu 3161, Service menu 316f, Audio menu 316g, a Sources menu 316m, a Language menu 316n, a Startup Logo menu 316h, a Blank Screen menu 316i, and a System menu 316j. Each of these various menus will be described in more detail to provide an illustration of an embodiment of the present invention.

As described above, any one of the child menus may include directional indicators, indicating that selecting one of these options will take the user to the child menu for the selected option. Further, each menu may include an Exit option (not shown). The Exit option may include directional indicators (not shown) indicating that selecting the Exit option will take the user one level up to the Settings menu.

Each of the child menus may include selectable options that may link the user to another menu. For example, and not as a limitation, third-level Service menu 316f may include selectable options such as Exit, Factory Reset, Lamp Reset and Service Code (not shown). Third-level Audio menu 316g may include user-selectable options such as Exit, Treble, Bass, Balance, Fader and Volume (not shown). The Treble, Bass, Balance, Fader and Volume options each may be associated with a numerical value (not shown) indicating the adjustable value at which these options are currently set. Selecting one of these options may result in the appearance of a pop-up window including an adjustable slider, as described above.

Similarly, third-level Startup Logo menu 316h may include user-selectable options such as Exit, Default, Blank Screen, Captured and Capture New (not shown). The Default, Blank Screen and Captured options may include radio buttons (not shown) allowing the user to select the desired option from the list.

Third-level Blank Screen menu 316i may include user-selectable options such as Exit, Black, White, and Blue (not shown). The Black, White and Blue options each may include radio buttons, allowing the user to select from between these options.

Third-level System menu 316j may include user-selectable options such as Exit, Rear, Ceiling, Auto Power, Display Message, Power Save, Screen Saver and Output Resolution (not shown). The Rear, Ceiling, Auto Power, Display Message, Power Save and Screen Saver options each may be associated with a check box (not shown) that enables the user to turn these options on and off.

Third-level Effect Key menu 316k may include user-selectable options such as Exit, Blank, Mute, Logo, Aspect Ratio, Source, Auto Image, Freeze, Zoom and About (not shown). Similarly, third-level Network menu 3161 may include user-selectable options such as Exit, IP Address, Subnet Mask, Default Gateway, DHCP and Network Info (not shown). Likewise, third-level Sources menu 316m may include user-selectable options, such as Exit, Source 1, Source 2, Source 3, Source 4, Power-up Source or Autosource (not shown). Language menu 316n may include user-selectable options, such as Exit, Deutsch, English, Espanol, Francais, Italiano, Norsk, Portuguese, Russian, Japanese, Korean, Chinese Trad and Chinese Simp (not shown).

Some of the options on the third-level menus may provide access to fourth-level menus. For example, Network option on third-level Network menu 3161 may provide access to fourth-level Network Info menu 318f. Network Info menu 318f may include a level indicator with four dots, indicating that this is a fourth-level menu. The Network Info menu may have an Exit option (not shown) including a directional indicator (not shown) indicating that selecting this option will return the user one level up to the Network menu. The Network Info menu also may display informational content regarding the current network settings.

Similarly, options from third-level menu Sources 316m may provide access to fourth-level menus, such as Source 1 menu 318g, Source 2 menu 318h, Source 3 menu 318i, Source 4 menu 318j and Power-up Source menu 318k. Each of these menus may include level indicators with four dots, indicating that these are fourth-level menus. Each of these menus further may include a user-selectable Exit option (not shown) including directional indicators (not shown) indicating that selecting the Exit option will take the user one level up, to the Sources menu. Moreover, each of the menus may include user-selectable options such as Exit, Computer 1, Computer 2, Video 1, Video 2 and Video 3 (not shown).

Output Resolution option on third-level System menu 316j also may link a user to a fourth-level Output Resolution menu 3181. Output Resolution menu 3181 may include level indicators having four dots, indicating that this is a fourth-level menu. The Output Resolution menu further may include user-selectable options such as Exit, 800×600 and 848×480 (not shown). The Exit option may include a directional indicator (not shown), indicating that selecting the Exit option will take the user up one level to the system menu. The 800×600 and 848×480 options each may include radio buttons (not shown), which allow the user to select between the options.

FIG. 5 depicts an exemplary type of controls 300 that might be used to navigate through the menu system shown in FIG. 4. It will be appreciated that these controls may be incorporated within a controller located on the device itself, or on remote controller adapted to operate the device. As shown, the controls may include three user inputs, such as buttons: a first directional button 302, a second directional button 304 and a select button 306. In the example shown, the first directional button (the “up” button) includes an upwards pointing caret, or arrow, and the second directional button (the “down” button) includes a downwards pointing caret, or arrow. Of course, it will be appreciated that the controller might just as easily have “right” and “left” buttons instead of “up” and “down” buttons.

To navigate the menu system, the user need only move up or down the menu currently being viewed. Typically, the items on the menu are highlighted in turn as the user scans through them. Pressing the select button will activate the highlighted item.

For example, a user may wish to alter the volume setting on the device. The user accesses the main menu, for example, by pressing a menu button on the controller, and then, using the up and down buttons on the controller, scrolling down the menu items until the Settings option is highlighted. The user then presses the select button to move to the Settings menu. The user then scrolls down the Settings menu until the Audio item is highlighted. The user then presses the select button to move to the Audio menu. The user then scrolls down the Audio menu until the Volume item is highlighted. The user then presses the select button and a pop-up window including a movable slider (or other suitable user interface) appears. The user may then raise or lower the movable slider using the up and down buttons (or any other suitable buttons) on the controller to adjust and set the volume level. Once the desired volume is indicated on the movable slider, the user may press the select button to return to the Audio menu. The user may then scroll up to the Exit item on the Audio menu and press the select button to return to the Settings menu. The user may then scroll up to the Exit item on the Setting menu and press the select button to return to the Main menu.

As described above, FIG. 6 illustrates one type of device which may utilize the menu navigation system. It further should be understood that the controls illustrated in FIG. 5 may be disposed on or incorporated within any suitable device, including projection device 9 shown in FIG. 6.

While the invention has been described primarily in the context of a menu system for navigation of a projection device, it should be understood that the present invention may be incorporated into a wide variety of menu systems where the menus are viewed on a display.

The disclosure set forth above encompasses multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions and/or properties disclosed herein.

The following claims particularly point out certain combinations and subcombinations regarded as novel and nonobvious and directed to one of the inventions. These claims may refer to “an” element or “a first” element or the equivalent thereof; such claims should be understood to include incorporation of one or more such elements, neither requiring, nor excluding, two or more such elements. Inventions embodied in other combinations and subcombinations of features, functions, elements, and/or properties may be claimed through amendment of the present claims or through presentation of new claims in this or a related application. Such claims, whether directed to a different invention or to the same invention, and whether broader, narrower, equal, or different in scope to the original claims, also are regarded as included within the subject matter of the inventions of the present disclosure.

1-18. (canceled)

19. An electronic device comprising:
a processor;
memory holding instructions that, when executed by the processor, provide a user interface having a cascading menu system, the cascading menu system comprising a plurality of increasingly deep levels, at least one level including a parent menu, and at least one level including a child menu;
wherein each parent menu includes one or more parent-menu selections, at least one parent-menu selection linked to and providing access to a child menu in a next deeper level;
wherein each child menu includes one or more child-menu selections, at least one child-menu selection linked to and providing access to a parent menu, which provides access back to that child menu; and
wherein each parent menu and each child menu on a level further includes one or more graphic elements corresponding in number to a depth of the level in the menu system; and
a display operatively coupled to the processor and adapted to display each parent and child menu one at a time, such that each child menu is accessed only in response to a linked parent-menu selection being selected, and
wherein a parent menu to which the linked parent-menu selection belongs ceases to be displayed upon selection of the linked parent-menu selection.

20. The electronic device of claim 19, wherein each child-menu selection providing access to a parent menu further comprises a directional indicator oriented in a first direction, and each parent-menu selection providing access to a child menu further comprises a directional indicator oriented in a second direction, opposite the first direction.

21. The electronic device of claim 19, wherein the electronic device is a projector.

22. The electronic device of claim 21, wherein the display is a projection display.

23. The electronic device of claim 21, wherein the display is a built-in display screen.

24. The electronic device of claim 23, wherein selecting at least one child-menu selection enables a setting of the projector to be changed.

25. The electronic device of claim 24, wherein setting affects a projection display.

26. The electronic device of claim 19, wherein the one or more graphical elements includes a set of dots arranged horizontally.

27. The electronic device of claim 19, further comprising a control pad operatively coupled to the processor and configured to enable selection of each parent-menu selection and each child-menu selection.

28. An electronic device, comprising:
a processor; and
memory holding instructions that, when executed by the processor, provide a user interface having a plurality of menu levels, the user interface comprising:
one or more parent menus including one or more parent-menu selections, each parent menu below the top menu level linked to a child-menu selection; and
one or more child menus, each child menu linked to a parent-menu selection and including one or more child-menu selections;
wherein each parent menu and each child menu includes a visual menu-level indicator, each visual menu-level indicator being identical for all parent and child menus of a same menu level and unique for all parent and child menus of different menu levels;
a display operatively coupled to the processor and adapted to display one parent or child menu at a time, exclusive of other display content.

29. The electronic device of claim 28, wherein each child-menu selection providing access to a parent menu further comprises a directional indicator oriented in a first direction, and each parent-menu selection providing access to a child menu further comprises a directional indicator oriented in a second direction, opposite the first direction.

30. The electronic device of claim 28, wherein the electronic device is a projector.

31. The electronic device of claim 30, wherein the display is a projection display.

32. The electronic device of claim 30, wherein the display is a built-in display screen.

33. An electronic device having a setting and comprising:
a control pad including first, second, and third buttons;
a display unit;
a processor operatively coupled to the control pad and the display unit and configured to cause the display unit to display a visible menu image,
wherein the visible menu image is one of a series of menu images ranked by a numeric level, the series of menu images including a superior menu image of lower numeric level than the visible menu image and an inferior menu image of higher numeric level than the visible menu image,
the visible menu image including a graphical object positively identifying the numeric level of the visible menu image in the series of menu images, and further including a plurality of choices arranged vertically, the plurality of choices including a choice for navigating to the superior menu image and either: one or more choices for navigating to the inferior menu-image, or one or more setting choices;
the processor further configured to:
highlight one of the plurality of choices in response to the first or third button being pressed;
display the superior menu image in response to the second button being pressed when the choice for navigating to the superior menu image is highlighted;
display the inferior menu image in response to the second button being pressed when the choice for navigating to the inferior menu image is highlighted; and
enable the setting to be changed in response to the second button being pressed when the setting choice is highlighted.

34. The electronic device of claim 33, wherein the choice for navigating to the superior menu image includes a directional indicator oriented in a first direction, and the choice for navigating to the inferior menu image includes a directional indicator oriented in a second direction, opposite the first direction.

35. The electronic device of claim 33, wherein enabling the setting to be changed in response to the second button being pressed comprises displaying a user-adjustable slider bar, wherein the setting changes responsive to a position of the slider bar changing.

36. The electronic device of claim 33, wherein the graphical object comprises one or more graphic elements corresponding in number to the numeric level of the visible menu image.

37. The electronic device of claim 33, wherein the graphical object is a numeral.

38. The electronic device of claim 33, wherein the graphical object is an icon.
